(19) United States
(12) Patent Application Publication
(10) Pub. No.: US 2004/0120159 A1
(43) Pub. Date: Jun. 24, 2004

(54) Head lamp for vehicle

(76) Inventor: Takaaki Nishizawa, Shizuoka (JP)

Correspondence Address: FISH & RICHARDSON P.C., 45 ROCKEFELLER PLAZA, SUITE 2800, NEW YORK, NY, 10111, US

(21) Appl. No.: 10/730,777

(22) Filed: Dec. 8, 2003

(30) Foreign Application Priority Data
Dec. 20, 2002 (JP) P.2002-369775

(51) Int. Cl. F21V 17/02

(52) U.S. Cl. 362/512

(57) ABSTRACT

A head lamp for a vehicle includes a lamp body, a reflector supported by the lamp body so as to tilt freely and a reflector tilting means for tilting the reflector, wherein the reflector tilting means is attached to an attachment portion provided within the lamp body, and the reflector tilting means is coupled to the reflector at a backward position from the attachment portion.

### BACKGROUND OF THE INVENTION

The present invention relates to a new head lamp for a vehicle and, more particularly, relates to an art of reducing the protruding degree in the backward direction of the head lamp for a vehicle, in the head lamp for a vehicle arranged to be able to change automatically or remotely the irradiation direction of a light beam with respect to a vehicle body.

In a head lamp for a vehicle, for example, in a head lamp for an automobile, the irradiation direction of a light beam, that is, an angle of the irradiation axis of a light beam with respect to a vehicle body is quite important. For example, when the irradiation axis of a light beam is directed in a too lower direction, a running road can not be irradiated sufficiently. In contrast, when the irradiation axis of a light beam is directed in a too upper direction, there arises a problem that a glare light is applied to oncoming cars, a preceding car, walkers etc.

Thus, in the head lamp for an automobile, the adjustment for the light-beam irradiation axis generally called an initial aiming is performed. That, is, at the time of shipping an automobile, before an automobile is delivered to a user from a manufacturing company, the light-beam irradiation axis is adjusted so as to be suitable in a no-load state or a state where only a driver rides on an automobile.

However, when a vehicle body tilts in a manner that the front portion thereof drops or rises due to the increase of passengers or the mounting of a load, the light-beam irradiation axis does not become suitable with respect to the road surface. As a result, the front portion of the vehicle body drops and tilts from the suitable angle and so a running road can not be irradiated sufficiently. In contrast, a glare light is applied to oncoming cars, a preceding car, walkers etc.

Thus, for example, as shown in JP-A-07-130206 (Japanese Application Publication Number: Hei07-130206), a head lamp for a vehicle mounting a leveling device thereon is proposed.

The leveling device is driven by a remote control from a driver's cabin or driven automatically based on the detection result of a sensor for detecting the inclination or tilt of a vehicle body, whereby an adjusting screw moves in the longitudinal direction. Thus, since a portion coupled to the adjusting screw of a reflector supported by a lamp body so as to tilt freely moves in the longitudinal direction, the reflector drops or raises at its front portion with respect to the vehicle body, whereby the angle of the light-beam irradiation axis with respect to the vehicle body is adjusted so as to correspond to the angle of the vehicle body with respect to the road surface.

The light-beam irradiation axis is always kept in a suitable state by the aforesaid leveling device regardless of the tilt of the vehicle body with respect to the road surface.

As disclosed in JP-A-07-130206, the head lamp for a vehicle mounting the leveling device thereon has a problem that the leveling device protrudes to a large extent in the backward direction of the lamp body, and so the depth of the head lamp for a vehicle becomes large.

In recent years, the sizes of the overhangs of automobiles becomes smaller, and so there have been increasing such automobiles in each of which a wheel house is disposed just at the rear side of a head lamp. In such automobiles, the increase of the depth of a head lamp influences on the design of automobiles.

Further, such a structure that the leveling device being a precision device protrudes in the backward direction of the lamp body causes a risk that the leveling device is made collide with an outside member during a carrying procedure or an attachment procedure to a vehicle body and so the leveling device may be damaged by the collision.

### SUMMARY OF THE INVENTION

Accordingly, the invention relates to a technique for preventing a reflector tilting means, which tilts a reflector automatically or through remote control thereby to change a light-beam irradiation angle with respect to a vehicle body, from protruding backward from a lamp body.

In order to solve the aforesaid problem, a head lamp for a vehicle according to the invention is arranged to include a lamp body, a reflector supported by the lamp body so as to tilt freely and a reflector tilting means for tilting the reflector, wherein the reflector tilting means is attached to an attachment portion provided within the lamp body, and the reflector tilting means is coupled to the reflector at a backward position from the attachment portion.

Thus, in the head lamp for a vehicle according to the invention, the reflector tilting means can be disposed at the space within the lamp body, so that the portion particularly protruding backward due to the provision of the reflector tilting means can be prevented from being formed at the lamp body.

### BRIEF DESCRIPTION OF THE DRAWING

FIG. 1 is a front view of a head lamp for a vehicle according to the invention.

FIG. 2 is a sectional view cut along a line II-II in FIG. 1.

FIG. 3 is a sectional view cut along a line III-III in FIG. 1.

FIG. 4 is a perspective view showing a state where an attachment portion for attaching a reflector tilting means is separated from a lamp body.

### DESCRIPTION OF THE PREFERRED EMBODIMENT

The embodiment of a head lamp for a vehicle according to the invention will be explained with reference to the accompanying drawings. Incidentally, the embodiment shown in the drawings is one in which the invention is applied to a head lamp for an automobile.

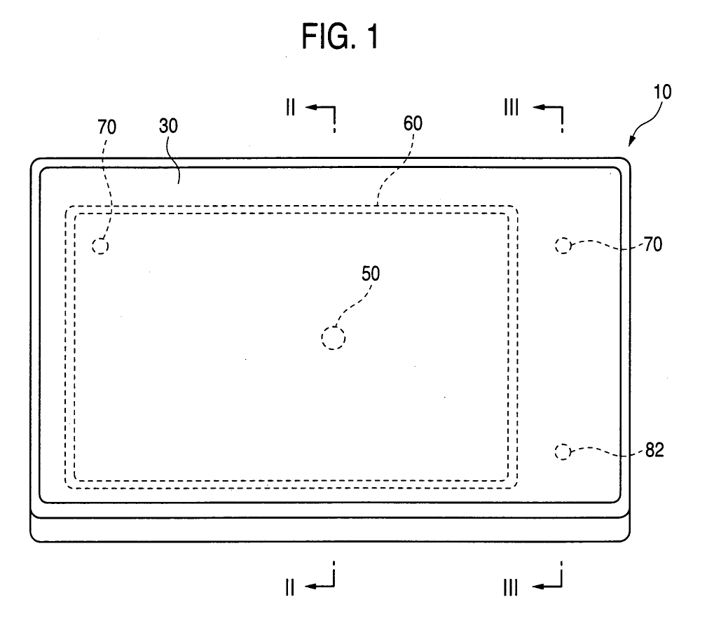

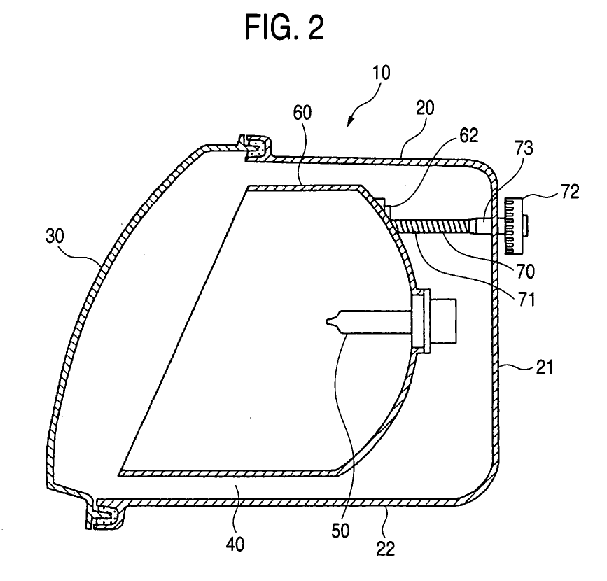

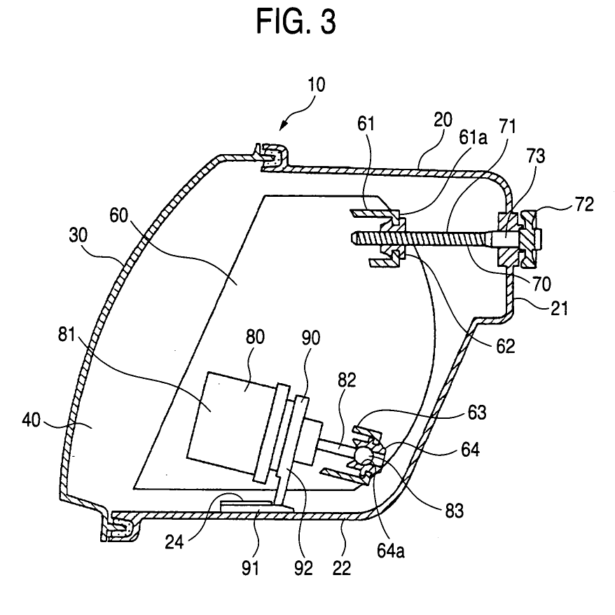

As understood from FIG. 1, FIG. 2 and FIG. 3, a head lamp for an automobile 10 is arranged in a manner that the front opening of a lamp body 20 having a concave portion opened toward the forward direction is covered by a transparent front cover 30 thereby to form a lamp chamber 40, and a reflector 60 which holds a valve 50 so as to be detachable freely is disposed so as to tilt freely within the lamp chamber 40.

The reflector 60 is supported by the lamp body 20 so as to tilt freely by means of two adjusting screws 70, 70 and a leveling device 80. The reflector 60 is arranged in a manner that its two upper portion separated in the horizontal direction are supported by the lamp body 20 by means of the adjusting screws 70, 70, respectively, and a portion thereof beneath the one of the adjusting screws 70 is supported by the lamp body 20 by means of the leveling device 80.

One of the adjusting screws 70 is arranged in a manner that a spiral shaft portion 71, a gear portion 72 and a supported portion 73 positioned at the center portion therebetween are integrally formed, and the supported portion 73 is rotatably supported at the rear surface wall 21 of the lamp body 20. The gear portion 72 is formed in a crown gear shape and positioned at the rear surface side of the rear surface wall 21 of the lamp body 20. The other adjusting screw 70 is configured in the same manner.

Stays 61, 61 (only one is shown in FIG. 3) are protruded backward from the two positions of the rear surface separated in the horizontal direction at the upper end side of the reflector 60. Nut bodies 62, 62 are supported at supporting portions 61a, 61a formed at the rear ends of the stays 61, 61, respectively. The spiral shaft portions 71, 71 of the adjusting screws 70, 70 are engaged with the nut bodies 62, 62, respectively. Thus, when the adjusting screws 70, 70 are rotated, a distance between the rear surface wall 21 of the lamp body 20 and the portions of the reflector 60 supporting the nut bodies 62, 62 changes. That is, when the adjusting screw 70 is rotated in a direction of screwing into the nut body 62, the distance between the rear surface wall 21 of the lamp body 20 and the portion of the reflector 60 supporting the nut body 62 becomes shorter. In contrast, when the adjusting screw 70 is rotated in a direction of disengaging from the nut body 62, the distance between the rear surface wall 21 of the lamp body 20 and the portion of the reflector 60 supporting the nut body 62 becomes longer. Incidentally, the adjusting screw 70 is rotated by a suitable jig. For example, the tip end portion of a jig having a plus-driver shaped tip end (a plus-driver itself may be used) is inserted between the rear surface wall 21 of the lamp body 20 and the gear portion 72 of the adjusting screw 70, and then the projection of the tip end portion of the jig is meshed with the gear wheel of the gear portion 72. In this state, when the jig is rotated, the gear portion 72 is fed by the projection of the tip end portion of the jig, and so the adjusting screw 70 is rotated.

As understood from FIG. 3, another stay 63 is protruded backward from a portion of the reflector 60 positioned beneath one of the stays 61, 61 at the rear surface on the lower end side of the reflector 60. A ball receiving body 64 is supported at a supporting portion 63a formed at the rear end of the stay 63. A spherical concave portion 64a opened in the forward direction is formed at the ball receiving body 64.

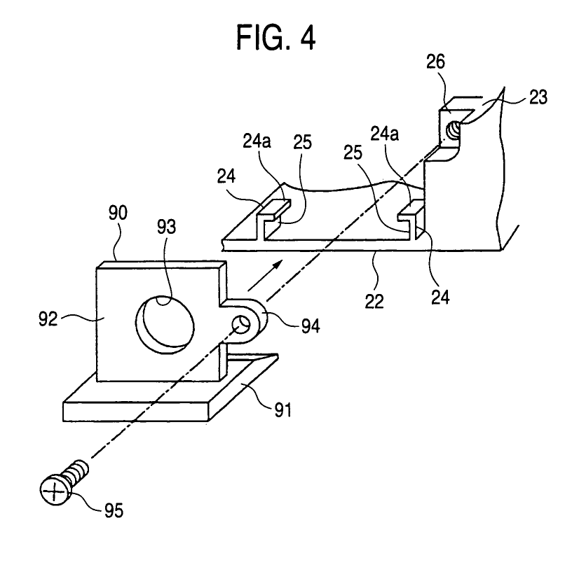

The leveling device 80 serving as a reflector tilting means is supported by the lamp body 20 through an attachment portion 90. As understood from FIGS. 3 and 4, the attachment portion 90 is integrally formed by a flat plate-shaped base 91 and a supporting portion 92 protruded upward from the upper surface of the base 91. An attachment hole 93 is formed at an almost center portion of the supporting portion 92, and a fixed tab 94 is protruded from the one side edge of the supporting portion 92. As clear from FIG. 4, at a portion close to one of the side surface walls 23 of the bottom surface wall 22 of the lamp body 20, two pressing projections 24, 24 are formed to extend in the longitudinal direction so as to be separated in the horizontal direction. These pressing projections 24, 24 are provided at their upper ends with pressing pieces 24a, 24a protruding so as to close to each other, respectively. The bottom surface wall 22 and the pressing projections 24, 24 form two supporting grooves 25, 25 which oppose to each other. A screw cramp supporting portion 26 directed to the forward direction is formed at one of the side surface walls. 23. Thus, the both side edges of the base 91 of the attachment portion 90 are inserted from their front side into the supporting grooves 25, 25 formed on the bottom surface wall 22 of the lamp body 20, respectively. Then, when the both side edges of the base 91 are inserted into the supporting grooves 25, 25 to some extent, the fixed tab 94 abuts against the screw cramp supporting portion 26 of the side surface wall 23 of the lamp body 20. Then, the attachment portion is screwed and engaged with the screw cramp supporting portion 26 of the lamp body 20 in a state that a screw 95 is passed through the fixed tab 94 of the attachment portion 90. As a result, the attachment portion 90 is integrally fixed to the lamp body 20.

Incidentally, although it is possible to integrally form the attachment portion 90 with the lamp body 20, a slide type die is required in order to form them integrally, which results in that a molding die for the lamp body 20 becomes expensive. In order to obviate such a problem, as described above, the attachment portion 90 is formed separately from the lamp body 20 in advance, and the attachment portion is integrated with the lamp body 20 thereafter through fastening using a screw etc. Thus, the molding die for the lamp body 20 can be manufactured at a low cost. In this manner, the attachment portion 90 can be provided easily at the lamp body 20.

The leveling device 80 is arranged in a manner that a not-shown driving source such as a motor or a solenoid and a power transmission means for transmitting the power of the driving source are disposed within a case body 81. As understood from FIG. 3, a leveling shaft 82, which is moved in the axial direction through the power transmission means by the driving force of the driving source, is disposed so as to protrude from the one end portion of the case body 81. A ball 83 is integrally formed at the tip portion of the leveling shaft 82. The driving source is driven through remote control from a driver's cabin or driven automatically based on the detection result of a sensor for detecting the tilt of a vehicle body. As a result of the driving of the driving source, the leveling shaft 82 moves in the axial direction.

In the leveling device 80, the case body 81 is attached to the attachment hole 93 formed at the supporting portion 92 of the attachment portion 90 and the leveling shaft 82 is placed in a state of being protruded backward from the case body 81. Then, the ball 83 at the tip end of the leveling shaft 82 is rotatably fit into the spherical concave portion 64a of the ball receiving body 64 supported by the stay 63 of the reflector 60. In this manner, the one of the side portions at the lower end portion of the reflector 60 is supported by the lamp body 20 through the leveling device 80.

In the aforesaid head lamp for an automobile 10, the initial aiming, that is, the adjustment of the light-beam irradiating axis at the time of shipping from a factory or periodic inspection or at the time of exchanging the head lamp can be performed by rotating the adjusting screws 70, 70. That is, by rotating one of the adjusting screws 70, the reflector 60 tilts in a manner that a line connecting between the ball receiving body 64 coupled with the leveling device 80 and the nut body 62 in which the remaining adjusting screw 70 is screwed serves as a tilt shaft. When both the two adjusting screws 70, 70 are rotated by the same rotation angle in the same direction, the reflector 60 tilts in almost the vertical direction in a manner that a line extending in parallel to a line connecting the two nut bodies 62, 62 through the ball receiving body 64 serves as a tilt shaft. When the vehicle body tilts in the longitudinal direction due to the change of the number of passengers or the sitting position of passengers or the change of amount of a load being mounted or the mounting position of a load, the leveling device 80 is driven manually or automatically, whereby the reflector 60 tilts almost in the vertical direction in a manner that a line coupling between the two nut bodies 62, 62 serves as a tilt shaft.

In the aforesaid head lamp for an automobile, the leveling device 80 serving as the reflector tilting means is disposed within the lamp body 20, and the reflector 60 is coupled with the leveling device 80 at the position backward from the attachment portion 90 at which the leveling device 80 is attached. Thus, unlike the conventional technique, the reflector tilting device is prevented from protruding backward from the lamp body, whereby the backward portion of the lamp body 20 can be configured smoothly or simply and the width of the entire configuration can be made small.

Incidentally, if the front portion of the leveling device 80 is not covered by the reflector 60 (that is, the side edges of the reflector 60 do not extend to the front surface of the leveling device 80) and so the leveling device 80 may be seen from the forward direction, a dressing member called an extension etc. may be disposed at the forward position of the leveling device 80 in order to shield a portion between the side edges of the reflector 60 and the side surface of the lamp body 20 from the forward direction.

The shapes and configurations of the respective portions shown in the aforesaid embodiment are merely an example for materializing the invention at the time of embodying the invention, and so the technical scope of the invention should not be limitedly interpreted by the example.

As clear from the aforesaid description, the head lamp for a vehicle according to the invention comprises the lamp body, the reflector supported by the lamp body so as to tilt freely and the reflector tilting means for tilting the reflector, wherein the reflector tilting means is attached to the attachment portion provided within the lamp body, and the reflector tilting means is coupled to the reflector at the backward position from the attachment portion.

Thus, in the head lamp for a vehicle according to the invention, the reflector tilting means can be disposed at the space within the lamp body, so that the portion particularly protruding backward due to the provision of the reflector tilting means can be prevented from being formed at the lamp body. Therefore, the backward portion of the lamp body can be configured smoothly or simply and the width of the entire configuration can be made small.

Furthermore, the attachment portion is formed as a member separately provided from the lamp body and fixed to the lamp body by means of the fixing means such as the screw, so that the attachment portion can be easily provided at the lamp body.

Furthermore, the reflector is supported by the lamp body at the three points in total, that is, the upper side two points and the lower side point in a manner that the supporting at the lower side point is performed by the reflector tilting means. Thus, the initial aiming can be performed only by the adjustment of the upper side two points, the workability of the initial aiming is good.

What is claimed is:

1. A head lamp for a vehicle comprising:
a lamp body;
a reflector tiltably supported by the lamp body, and
a reflector tilting means for tilting the reflector,
wherein the reflector tilting means is attached to an attachment portion provided within the lamp body, and
the reflector tilting means is coupled to the reflector at a backward position from the attachment portion.

2. A head lamp for a vehicle according to claim 1,
wherein the reflector tilting means is a leveling device comprising a driving source and a leveling shaft,
the leveling device is attached to an attachment portion in a state where the leveling shaft is protruded backward, and
the leveling shaft is connected to the reflector.

3. A head lamp for a vehicle according to claim 1 wherein the attachment portion is formed as a member separately provided from the lamp body and fixed to the lamp body by a fixing means.

4. A head lamp for a vehicle according to claim 3 wherein the fixing means is a screw.

5. A head lamp for a vehicle according to claim 1,
wherein the reflector is supported by the lamp body at two points on an upper side and one point on a lower side, and
the support on the lower side is performed by the reflector tilting means.
